(19) United States
(12) Patent Application Publication
(10) Pub. No.: US 2016/0042310 A1
(43) Pub. Date: Feb. 11, 2016

(54) PRODUCT OPERATIONS TRACKING SYSTEM AND METHOD

(71) Applicant: JUAN LUIS YANEZ MENDEZ, Conroe, TX (US)

(72) Inventor: JUAN LUIS YANEZ MENDEZ, Conroe, TX (US)

(21) Appl. No.: 14/456,208

(22) Filed: Aug. 11, 2014

(51) Int. Cl. G06Q 10/08

(52) U.S. Cl. CPC G06Q 10/087

(57) ABSTRACT

A product operations tracking system involves an apparatus and system to track and monitor the operational use of assets, with an emphasis on tubular products in the oil and gas industry. A tracking device is manufactured into an end protector, such as a thread protector, attached to an asset, which in a preferred embodiment will include a camera, a GPS and related antennas, an on/off switch, a timer which may comprise software in a processor, and a power source. The removal of the end protector begins operation of a timer which will deactivate once thread connector is reconnected to the equipment to log actual usage history of the typically rented or leased asset. Once the equipment is returned to the owner, the record in the tracking device indicates the time of usage.

### BACKGROUND OF THE INVENTION

1. Field of the Invention

The present invention relates generally to monitoring and tracking systems, and more specifically to a product operations tracking system and method for oil and gas tubulars and tools.

2. Background of the Invention

In the oil and gas industry, tools and products are regularly shipped from a vendor or owner to a customer. Generally, these tools are used during the drilling operations. Additional tools are often ordered on a standby basis for scenarios in which the operational tool fails and a substitute is needed.

Without oversight and control, it is difficult to monitor how often the tools have been utilized while in the control of the customer. The tool could be utilized for several hours, days, or even months, with the owner or vendor dependent upon receiving the utilization timeframes from the client. In some cases, tools shipped back to owners in a visibly operated state, showing wear and tear and the presence of drilling fluid, are reported as having never been used. In another scenario, tools involved in inter-company asset transfers can be lost or misplaced in inventory, or be loaned out to third-parties without being reported to someone in operations to track the asset. The financial loss incurred when improperly billing for standby costs rather than operating costs can represent a huge sum for companies.

The following patents discuss background art related to the above discussed subject matter:

U.S. Pat. No. 5,360,967, issued Nov. 1, 1994, to Perkin, et al., discloses an apparatus for identifying equipment, including the maintenance of usage histories for the equipment and recommending whether the equipment is to be used in a prospective application based on prospective application and usage history. A portable encapsulated passive circuit capable of transmitting an identification code is affixed to a piece of equipment. The circuit is activated by a portable reader which receives and decodes the identification code and transmits it to a central computer. The central computer verifies the reader and the existence of the equipment in a database and retrieves the usage history for the equipment. Based on the usage history, the prospective application and guidelines for usage of equipment, the computer determines the advisability of using the equipment in the prospective application and transmits the recommendation back to the portable reader.

U.S. Pat. No. 6,973,416, issued Dec. 6, 2005, to Denny, et al., discloses an oilfield equipment identifying apparatus comprising a computer loaded with an oilfield equipment database. A unique identification code is input into the computer for each piece of oilfield equipment in the drill string to form a reference in the oilfield equipment database to each piece of oilfield equipment in the drill string. A drilling monitoring device receives input signals indicative of at least one of rotating and non-rotating usage of the drill string and output signals to the computer wherein the computer continuously and automatically monitors the cumulative rotating usage and non-rotating usage of each piece of oilfield equipment identified in the drill string.

U.S. Pat. No. 7,014,100, issued Mar. 21, 2006, to Zierolf, discloses an assembly and process for identifying and tracking assets, particularly tubulars, equipment, tools and/or devices. An antenna is electrically connected to a responding device, such as a radio frequency identification device, and this assembly is connected to an asset. The antenna may be positioned about the exterior and/or the interior of the asset and significantly increases the range of signals that may be received and/or broadcast by the responding device. A transceiver may accordingly be positioned a greater distance from the asset without regard to the orientation of the asset and still permit communication between the transceiver and the responding device. In this manner, information that specifically identifies the asset may be compiled in a data base so as to maintain an accurate history of the usage of such assets as tubulars, equipment, tool and/or devices.

U.S. Pat. No. 7,159,654, issued Jan. 9, 2007, to Ellison, et al., discloses apparatus identification systems and methods. A member having a body, the body having two spaced-apart ends, wave energizable identification apparatus which, in one aspect, is radio frequency identification apparatus with integrated circuit apparatus and antenna apparatus on the exterior of the body, and encasement structure encasing the identification apparatus, the encasement structure, in certain aspects, including one or a plurality of layers of heat resistant material and, in certain aspects, at least one layer of heat resistant material, and methods for producing such a member.

U.S. Pat. No. 7,474,218, issued Jan. 6, 2009, to Johnson, et al., discloses a system and method for managing enterprise assets located at geographically distributed sites utilizing wireless tag technologies. The method includes storing in a database information relating to each asset, wherein the stored information includes cost of each asset and cost of service for each asset. The method further includes tracking and storing information relating to servicing of the assets, including the cost of servicing. Information relating to the assets is then displayed to a user of the system.

U.S. Pat. No. 7,603,296, issued Oct. 13, 2009, to Whiteley, et al., discloses a method for monitoring well equipment during transport and storage. Items of equipment and assemblies for use in drilling or completion of a well or in other well operations are monitored from the time they are assembled for shipment to a particular well site for a job through the time of delivery and installation at the well site. Radio frequency identifier devices (RFID's) are mounted with the items to electronically tag them as they are assembled for shipment. The items are assembled into containers which can be readily inventoried during transit to detect loss or pilferage. Detailed information about the individual items can be encoded into the RFID at the time of electronic tagging. If desired, the shipping containers can be provided with separate RFID's detailing the particular items within the container and the progress of the shipment monitored remotely by satellite or the like.

U.S. Pat. No. 7,677,439, issued Mar. 16, 2010, to Zierolf, discloses an assembly and process for identifying and tracking assets, such as tubulars, equipment, tools and/or devices. An antenna is electrically connected to a responding device, such as a radio frequency identification device, and this assembly is connected to an asset. The antenna may be positioned about the exterior and/or the interior of the asset and significantly increases the range of signals that may be received and/or broadcast by the responding device. A transceiver may accordingly be positioned a greater distance from the asset without regard to the orientation of the asset and still permit communication between the transceiver and the responding device.

U.S. Pat. No. 7,912,678, issued Mar. 22, 2011, to Denny, et al., discloses a system for identifying a piece of oilfield equipment having an exterior surface, the system having an identifier assembly that includes an RFID tag storing a unique identifier, an enclosure receiving and retaining the RFID tag, and a reader.

U.S. Pat. No. 7,946,356, issued May 24, 2011, to Koederitz, et al., discloses a n item (e.g. a drill bit) handling method, the item for use in a well operation, the method including producing information about an item used for a specific well task, the information including design information and intended use information, producing an item identification specific to the item, associating the information with the item identification producing thereby an information package, installing the information package in at least one wave-energizable apparatus, and applying the at least one wave-energizable apparatus to the item.

U.S. Pat. No. 8,091,775, issued Jan. 10, 2012, to Zierolf, discloses an assembly and process for identifying and tracking assets, such as tubulars, equipment, tools and/or devices. An antenna is electrically connected to a responding device, such as a radio frequency identification device, and this assembly is connected to an asset. The antenna may be positioned about the exterior and/or the interior of the asset and significantly increases the range of signals that may be received and/or broadcast by the responding device. A transceiver may accordingly be positioned a greater distance from the asset without regard to the orientation of the asset and still permit communication between the transceiver and the responding device. In this manner, information that specifically identifies the asset may be compiled in a data base so as to maintain history of the usage of such assets as tubulars, equipment, tool and/or devices.

U.S. Pat. No. 8,463,664, issued Jun. 11, 2013, to Griggs, et al., discloses serialization and database methods for tubular and oilfield equipment. Methods and apparatus identify downhole equipment and correlate input data with the equipment to improve planning and/or inventory operations. For some embodiments, oilfield equipment or tubular goods such as drill pipe include a shaped recess along an outer circumference for receiving a tag cartridge by shrink fitting. Once tagged, detector system configurations at pipe yards may facilitate logging the presence and location of each drill pipe and correlating specific data, such as inspection data, to each drill pipe. Further, this correlation populates a database utilized to achieve other business functions such as forecasting number of additional drill pipe needed to purchase, invoicing customers according to actual tracked wear/use of the drill pipe being returned, and providing well or job specific drill string population using known history pipe joints.

U.S. Patent Application No. 2013/0063277, published Mar. 14, 2013, to

Christiansen, discloses a system and method for managing use of a downhole asset. In one embodiment, a system includes a rig interface, a tag reader, and FIG. 1 a remote datacenter. The rig interface is disposed proximate to a borehole being drilled, and configured to process information related to use and physical condition of the downhole asset while drilling the borehole. The tag reader is configured to transfer a measurement of an attribute of the downhole asset to the rig interface. The remote datacenter is disposed remote from the borehole and is configured to assess the condition of the downhole asset based on information received from the rig interface and additional information related to use of the downhole asset received by the remote datacenter over the life of the downhole asset.

The above prior art does not provide a suitable solution to the above and/or other problems. There exists a need for an improved product operations tracking system. Consequently, those skilled in the art will appreciate the present invention that addresses the above and/or other problems.

### SUMMARY OF THE INVENTION

An object of the present invention is to provide an improved product operations tracking system.

Another object of the present invention is to provide an improved product operations tracking system which more accurately tracks the utilization time for the product being monitored.

Yet another object of the present invention is to provide a product operations tracking system which can track a physical location of a product and verify correct product is being monitored.

These and other objects, features, and advantages of the present invention will become clear from the figures and description given hereinafter. It is understood that the objects listed above are not all inclusive and are only intended to aid in understanding the present invention, not to limit the bounds of the present invention in any way.

In accordance with the present disclosure, one possible embodiment of a product operations tracking system may include, but is not limited to, a thread protector connectable with the threaded member of a tool, a switch mounted to the thread protector and being configured to detect removal and replacement of the thread protector from the tool, a timer operably connected to the switch to track a utilization time, and a power source operably connected to the switch and the timer.

More generally the present invention utilizes an end protector, which may comprise a thread protector, end cap, sleeve, plug or the like.

The timer and the switch may be configured so that when the end protector/thread protector is removed from the tool, the timer initiates counting the utilization time.

The system may comprise an identifier tag on the tool, wherein the identifier tag comprises at least one of a barcode, a QR code, and/or a serial number.

The system may further comprise a camera mounted to the end protector/thread protector and positioned to observe and take a picture of the identifier tag. In another embodiment, a GPS antenna for determining a location of the tool may be included with the product operations tracking system.

In one embodiment, the timer may further comprise software and a processor. In another embodiment, the tool may comprise an oil and gas tubular.

The system may further comprise at least one of a database or memory to store at least one of the utilization time, the location, and the picture of the identifier tag. The switch may include at least one of a mechanical switch, a light based switch, or a digital switch.

In another embodiment of the present invention, a method for a product operations tracking system for use with a tool comprising an end to be protected during non-use with an end protector being removed during use of the tool. The method may comprise steps such as providing an end protector connectable with an end of the tool, mounting a switch to the end protector configured to detect removal of the end protector from the tool, operably connecting a timer to the switch to track a utilization time, and operably connecting a power source to the switch and the timer.

The method may further comprise providing the timer and switch are configured so that when the end protector is removed from the tool, the timer initiates counting the utilization time. Another step may comprise providing an identifier tag on the tool, wherein the identifier tag comprises at least one of a barcode, a QR code, and/or a serial number.

The method may comprise further steps, such as mounting a camera to the end protector positioned to observe and take a picture of the identifier tag, and providing a GPS antenna for determining a location of the tool.

Other steps may include providing the timer further comprises software and a processor, providing the tool comprises an oil and gas tubular, providing at least one of a database or memory to store at least one of the utilization time, the location, and the picture of the identifier tag, and providing the switch is at least one of a mechanical switch, a light based switch, or a digital switch.

In yet another embodiment of the present invention, a system for tracking usage of an oilfield tubular is presented, comprising, but not limited to, a removable member mountable to the oilfield tubular, and a timer built into the removable member to detect use of the oilfield tubular, whereupon the removable member is removable from the oilfield tubular for access to the electronic usage detection system to determine the usage of the equipment.

The system may further comprise a timer built into the removable member.

### BRIEF DESCRIPTION OF THE DRAWINGS

The above general description and the following detailed description are merely illustrative of the generic invention, and additional modes, advantages, and particulars of this invention will be readily suggested to those skilled in the art without departing from the spirit and scope of the invention. A more complete understanding of the invention and many of the attendant advantages thereto will be readily appreciated by reference to the following detailed description when considered in conjunction with the accompanying drawings, wherein like reference numerals refer to like parts and wherein:

FIG. 1 is an elevational view, in section, of a product operations tracking system in accord with one possible embodiment of the present invention.

FIG. 2 is a perspective view of a product operations tracking system with thread protector type of end protector removed from tool in accord with one possible embodiment of the present invention.

FIG. 3 is a block diagram of a product operations tracking system in accord with one possible embodiment of the present invention.

FIG. 4 is block diagram of another embodiment of a product operations tracking system in accord with one possible embodiment of the present invention.

FIG. 5 is a flowchart of the life cycle for a product operations tracking system in accord with one possible embodiment of the present invention.

### DETAILED DESCRIPTION OF THE PREFERRED EMBODIMENT

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

In a preferred embodiment, product operations tracking system is designed to track when a product is being utilized. A product will have a connection with the tracking device and allow for operational tracking of the product once the tracking device is removed. In a preferred embodiment, the system is designed so that the tracking device is removed in order to operate the product. The customer by contract will be aware that once the tracking device is removed, billing will be at an operational rate and not a standby rate. The system will show that the tool was utilized and provide an estimated time in operations. When operations of the product are completed or there is a need to stop the time of use, the customer will reconnect the tracking device to the product or tool.

While the preferred embodiment of the present invention relates generally to the oil and gas industry, the application of this system could be used to track products used in other industries, such as, but not limited to, aerospace, transportation, retail, and the like.

Turning now to FIG. 1, there is shown an elevational view in section of product operations tracking system 100. In this embodiment, thread protector 60 is fully connected with tool 50. Thread protectors, end caps, sleeves, plugs, and the like are commonly used to preserve the integrity of the threadable portion, exterior surface, components of oilfield tools, tubular, equipment, machinery, and the like. While the present invention is described in terms of thread protector 60, it will be appreciated that the present invention could be utilized with any type of end protector that includes thread protectors, end caps, sleeves, plugs, and the like. Therefore, as used herein, the term end protector will be used interchangeably and will be understood to encompass thread protectors, end caps, sleeves, plugs, and the like. End protectors are generally used with oilfield tubulars to protect the ends that may comprise threads, finish, interior components or the like, when the tool is not in use. In some cases, end protectors may not utilize threads and may instead may be press fit onto the end of the oilfield tubular. End protectors are normally required to be removed prior to operation of the tool. Once the tool is no longer being used, then the end protectors are replaced to protect the ends of the tool.

End protector/Thread protector 60 comprises tracking components to be described hereinafter to monitor product or tool 50. End protector/thread protector 60 may be clearly marked for this purpose and may have an unusual shape so as to identify itself for this purpose. The contract for use of the tool may specify that thread protector 60 is utilized. In this disclosure, tool 50 may also be referred to as machine, equipment, tubular, product and the like, consistent within the teachings of this disclosure. End protector/Thread protector 60 is of a generic variety and could comprise any conceivable shape, provided it comprises threadable portion 62 which engage with threadable portion 52 of tool 50 to provide thread protection. In a preferred embodiment, end protector/thread protector 60 comprises a rubber material, PFTE material, polymeric material, non-metallic materials, or the like, but could conceivably be made with any material suitable including plastic, metal, and the like for attaching with tool 50 without harming threadable portion 52, or other portions.

In this embodiment, switch 10 is positioned on inner shoulder 12 of end protector/thread protector 60 to activate and deactivate the various tracking components of product operations tracking system 100. Battery 40 powers the tracking components, including detector/camera 20, GPS 30, and processor or timer 70. Switch 10 is positioned to engage tool wall end 14 when thread protector end 44 contacts tool shoulder 42. In other embodiments, switch 10 may be included in other portions of end protector/thread protector 60, provided that switch 10 is positioned to be operable to detect when end protector/thread protector 60 is removed from and reconnected to tool 50. Switch 10 is operably connected to processor 70 which is connected with camera 20 and GPS 30. In a preferred embodiment, switch 10 is a mechanical switch. However, the invention is not limited to a mechanical switch and may comprise any type of electronic switch including motion detector or the like whereupon proximity to the tool, relative motion or rotating motion with respect to the tool acts to turn on power to a processor or timer. Processor 70 may comprise a programmed timer or may be a dedicated timer circuit as discussed hereinafter. If desired, a processor 70 could be utilized with a separate timer 72. If desired, a solar cell may be built into battery 40 for charging the battery.

Detector/camera 20 is used to verify asset utilization and/or tracking information by taking pictures of identification code or marking 56 to ensure thread protector 60 is connected and/or removed from the same tool 50. Detector/camera 20 may comprise cameras or any other suitable means to verify the use of the same tool 50 such as an RFID, bar code, RFID reader or bar code reader. Other types of devices and codes for verifying the same tool may be utilized for this purpose. Accordingly, detector/camera 20 as used herein broadly refers to any means of verifying that the same tool is being utilized with system 100. This prevents end protector/thread protector 60 from being connected to a different piece of equipment, to stop the tracking of utilization time for tool 50. GPS 30 is embedded within thread protector 60 to provide a location for tool 50 and to further verify status of tool 50. In this preferred embodiment, GPS 30 also comprises antenna 32 for transmitting information and allowing interrogation of product operations tracking system 100. In alternative embodiments, GPS 30 may have an integrated antenna and antenna 32 may be omitted. If desired, GPS 30 and antenna 32 may also comprise cellular telephone circuitry and antenna for broadcasting the information. However, in a preferred embodiment, non-volatile memory is utilized to keep a record of tool usage, whereupon the memory is read upon return of the tool.

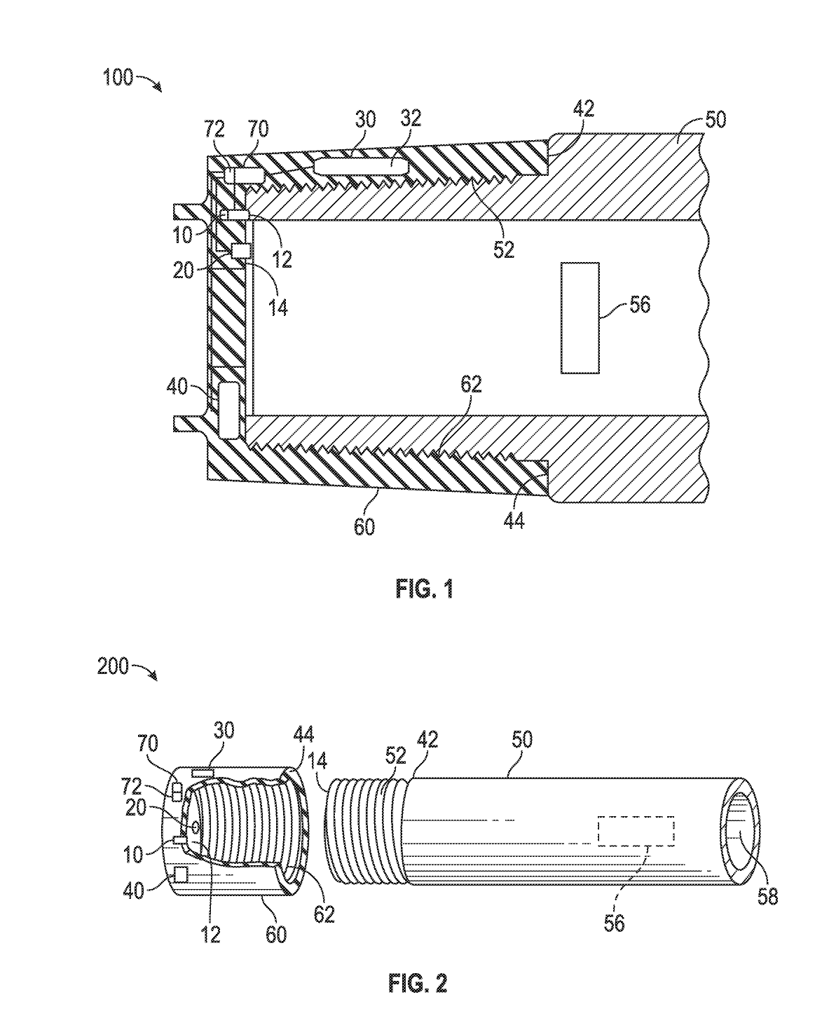

FIG. 2 shows another perspective view of product operations tracking system 200 with end protector/thread protector 60 fully removed from tool 50. Product Operations Tracking system 200 has detector/camera 20 positioned to verify operations utilization and/or tracking information by taking pictures of ID bar code, QC code, RFID, or markings 56 to prevent thread protector 60 from being connected to a different piece of equipment. As discussed hereinbefore, barcode or any type of identifying marking or identifier 56 could be located on inner wall 58 of tool 50 or at any desired location as shown in FIG. 1. Processor/timer 70 can be activated when thread protector 60 is removed from tool 50 activating switch 10. Processor/timer 70 is deactivated when thread protector 60 is reconnected to corresponding tool 50. In other embodiments, timer 72 may be a timer circuit with memory, rather than software on processor 70. The timer and/or processor preferably comprises a non-volatile memory to keep track of multiple on and off useage.

In this embodiment, end protector/thread protector 60 and tool 50 connect by way of threadable portion 62 and threadable portion 52, respectively, whereby thread protector end 44 contacts tool shoulder 42 when fully connected. Switch 10 is positioned on inner shoulder 12 of thread protector 60 to engage tool wall end 14 when thread protector 60 is connected to tool 50.

The location of GPS 30, camera 20, processor 70, and battery 40 is not fixed within the end protector/thread protector, and can be moved consistent with the present invention where best suited for their function. For example, camera 20 is preferably located with a line of sight to the code to be read for a particular tool.

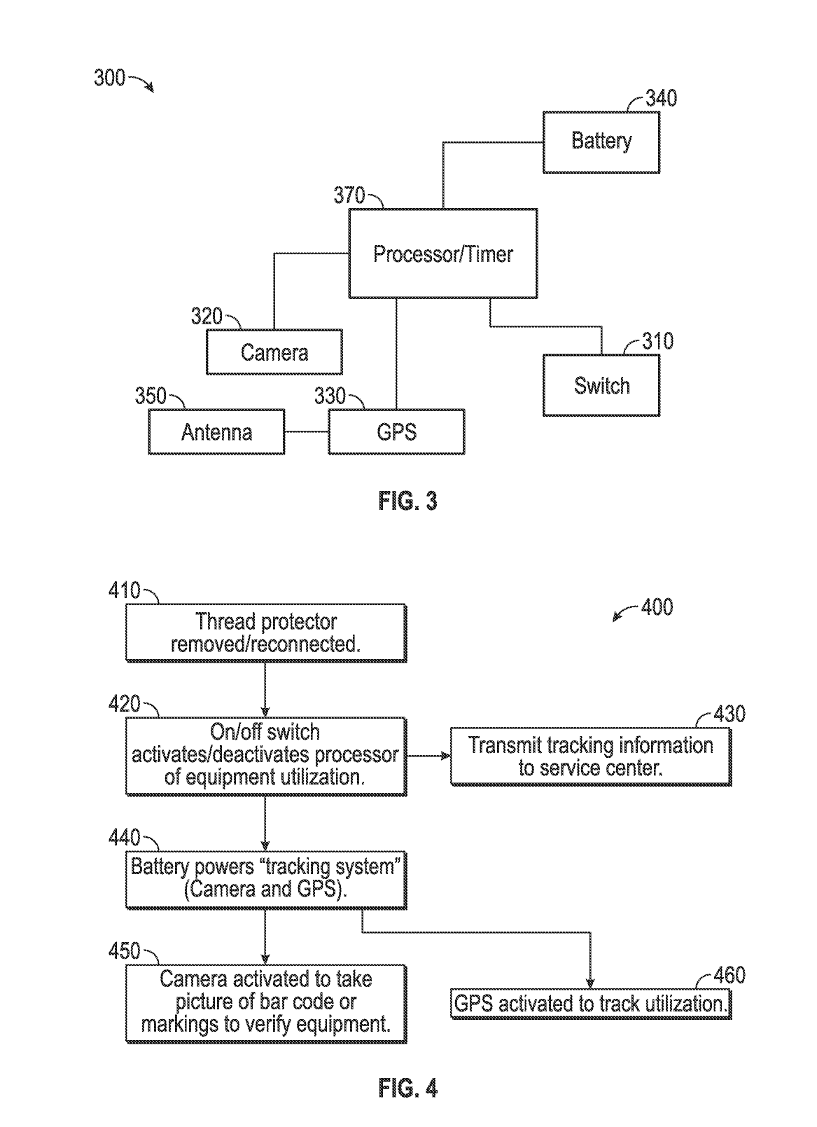

FIG. 3 is a block diagram of product operations tracking system 300 in accord with one possible embodiment of the present invention. Processor/timer 370 may comprise a software timer within a processor, a processor with separate timer, a dedicated timer circuit with non-volatile memory, or any other suitable circuitry to perform the intended timing function as discussed herein. Switch 310 may be used to turn the processor or dedicated timer on and off. Accordingly item 370 may be referred to herein as processor/timer 370. A non-volatile memory can be used to store each time of use of the tool.

Processor/timer 370 is operably connected with battery 340 to provide power for camera 320, GPS 330, and antenna 350. In one embodiment, the entire circuit may be turned off until turned on with switch 310. In another embodiment, a processor may operate in a sleep mode until turned on with switch 310. Once switch 310 is activated, processor/timer 370 initiates the timer function. Camera 320 takes a picture of or otherwise identifies tool identification mark 56 (See FIGS. 1 & 2). GPS 330 tracks the location of product operations tracking system 300. Configured in this arrangement, camera 320, GPS 330 and related antenna 350 will not draw power from battery 340 unless processor 370 allows for that function, e.g., after the switch 310 is activated.

When the end protector/thread protector is put back on to the tool, then switch 310 is deactivated. At this time, processor/timer 370 powers down and closes the connection between battery 340 and the remaining tracking components, i.e., GPS 330, antenna 350, and camera 320. The time and/or other information such as GPS information and/or cameral information is stored in a non-volatile memory for processor/timer 370 or non-volatile memories for GPS 330 or camera 320. In one embodiment, the last picture for each use by camera 320 will be obtained as the end protector/thread protector is being reconnected or shortly after reconnection to verify that the end protector/thread protector is placed on the same tool. As well, GPS 330 is preferably turned off when the thread connector is replaced.

The process repeats each time the end protector/thread protector is removed. The timer is started, a camera shot is taken and a GPS fix is attempted. When reconnected and switch 310 switches off, then processor/timer 370 obtains a time and stores the time in a non-volatile memory. The switch shuts off the camera. Alternatively, a camera shot is taken and/or a GPS position fix is attempted. Once the camera shot is completed and/or a GPS fix is obtained, then the processor/timer 370 powers off.

The above sequence discussed above is repeated each time the end protector/thread protector is removed/connected. When the tool is returned to the tool owner or lessor, the non-volatile memory downloaded to provide the information of use such as time and location of use. In one embodiment, this involves interrogating the non-volatile memory of processor/timer 370 to show the time of use for each use of the tool. The non-volatile memory of camera 320 (or other type of detector 320 such as RFID, bar code, or shows pictures of visual indicator 56 for each time the end protector/thread protector is removed or replaced.

FIG. 4 is an alternative block diagram of product operations tracking system 400 in accord with one possible embodiment of the present invention. First, end protector/thread protector 60 is removed or reconnected at 410. Next, switch activates and/or deactivates the processor with timer or dedicated timer circuit for utilization tracking of the tool at 420. Then at 440, the battery powers the tracking system, i.e., camera and GPS. Following step 440, the camera or other detector activates to take pictures of barcode or markings to verify equipment at 450, and GPS activates to track utilization of equipment and/or location of equipment at 460. Finally, tracking information transmitted to service center at 430. This may be accomplished by reading the non-volatile memory after return of the tool. The camera and timer may continue to operate until reconnected whereupon a final camera shot may be produced and the timer stops with the final time recorded in non-volatile memory. In one embodiment, the timer or processor begins a new time sequence for each subsequent use, which is stored in non-volatile memory. Likewise for each subsequent use a new camera shot is obtained and/or a GPS fix is attempted. In one embodiment, the present invention may comprise a cellular telephone circuit to transmit a signal at the time of removal and/or replacement. However, this type of circuit is often not available at remote rig locations.

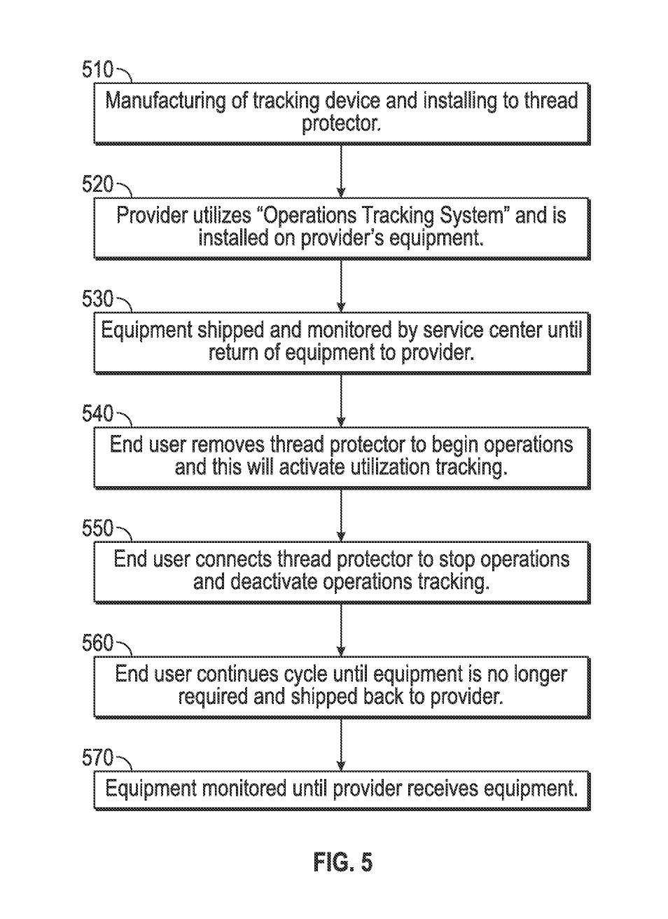

FIG. 5 is a flowchart of the life cycle for product operations tracking system 100 in accord with one possible embodiment of the present invention. Step 510 involves manufacturing of tracking component system within end protector/thread protector. The provider utilizes/initiates product operations tracking system and installs tracking end protector/thread protector on the equipment or tool at Step 520. The identifier of the tool may be built into the tool by some means such as etching, stamping, or the like. In Step 530, tracking end protector/thread protector and tool are shipped and monitored by service center (if a cellular telephone circuit is provided) until return of equipment to provider. At Step 540, the client or end user removes end protector/thread protector from tool to begin operations and this activates utilization tracking of tool by client. Next, end user terminates operation of equipment and reconnects end protector/thread protector to tool to deactivate utilization tracking at Step 550. At 560, the client continues cycle until equipment or tool is no longer required and shipped back to provider. Finally, at step 570 the equipment is shipped and returned to provider with service center tracking and acquired information regarding the utilization time of tool, the location history of asset, and the like.

In summary, the present invention provides various embodiments of an end protector/thread protector that is modified as shown in FIG. 1 or FIG. 2 with system 100 as discussed herein. Various configurations for the structure or organization of the invention are discussed in FIG. 3 and FIG. 4 as discussed herein. Possible non-limiting uses of the equipment are shown in FIG. 5 as discussed herein. While a thread protector is one preferred embodiment, any end protector, whether threaded or not, which is mountable to some location of the oilfield tubular could conceivably be utilized for timing of usage purposes although a thread protector is a presently preferred embodiment.

The foregoing description of the preferred embodiments of the invention has been presented for purposes of illustration and description only. It is not intended to be exhaustive nor to limit the invention to the precise form disclosed; and obviously many modifications and variations are possible in light of the above teaching. Such modifications and variations that may be apparent to a person skilled in the art are intended to be included within the scope of this invention as defined by the accompanying claims.

1. A product operations tracking system for use with an oilfield tool comprising a tool end, comprising:
an end protector connectable with said tool end of said oilfield tool when said oilfield tool is not in use, said end protector being positioned to require being removed prior to operation of said oilfield tool;
a switch mounted to said end protector and being configured to detect removal and replacement of said end protector from said oilfield tool;
a timer operably connected to said switch to track a utilization time based on time of removal of said end protector from said oilfield tool; and
a power source operably connected to said switch and said timer.

2. The system of claim 1, wherein said timer and said switch are configured so that when said end protector is removed from said oilfield tool, said timer initiates counting said utilization time.

3. The system of claim 1, further comprising an identifier tag on said oilfield tool, wherein said identifier tag comprises at least one of a barcode, a QR code, and/or a serial number.

4. The system of claim 3, further comprising a camera mounted to said end protector and positioned to observe and take a picture of said identifier tag.

5. The system of claim 1, further comprising a GPS antenna for determining a location of said oilfield tool.

6. The system of claim 1, wherein said timer further comprises software and a processor.

7. The system of claim 1, wherein said oilfield tool comprises an oil and gas tubular and said end protector comprises a thread protector.

8. The system of claim 1, further comprising at least one of a database or memory to store at least one of said utilization time, a location of said oilfield tool, and an image of an identifier tag from said oilfield tool.

9. The system of claim 1, wherein said switch is at least one of a mechanical switch, a light based switch, or a digital switch.

10. A method for a product operations tracking system for use with an oilfield tool comprising a tool end, comprising:
providing an end protector connectable with said tool end of said oilfield tool;
providing that said end protector is necessarily removed prior to operation of said oilfield tool;
mounting a switch to said end protector being configured to detect removal of said end protector from said oilfield tool;
operably connecting a timer to said switch to track a utilization time; and
operably connecting a power source to said switch and said timer.

11. The method of claim 10, further comprising providing said timer and switch are configured so that when said end protector is removed from said oilfield tool, said timer initiates counting said utilization time.

12. The method of claim 10, further comprising providing an identifier tag on said oilfield tool, wherein said identifier tag comprises at least one of a barcode, a QR code, and/or a serial number.

13. The method of claim 12, further comprising mounting a camera to said end protector positioned to observe and take a picture of said identifier tag.

14. The method of claim 13, further comprising providing a GPS antenna for determining a location of said oilfield tool.

15. The method of claim 10, further comprising providing said timer further comprises software and a processor.

16. The method of claim 10, further comprising providing said tool comprises an oil and gas tubular and said oilfield tool comprises a thread protector.

17. The method of claim 14, further comprising providing at least one of a database or memory to store at least one of said utilization time, said location, and said picture of said identifier tag.

18. The method of claim 10, further comprising providing said switch is at least one of a mechanical switch, a light based switch, or a digital switch.

19. A system for tracking usage of an oilfield tubular with an end, comprising:
a removable end protector mountable to said oilfield tubular; and
a timer and a switch built into said removable end protector to detect use of said oilfield tubular, whereupon said removable member is removable from said oilfield tubular for access to determine said usage of said oilfield tubular.

20. The system of claim 19, further comprising a processor operable for use with said switch to control said timer and a memory for storage of said usage of said oilfield tubular.
